(19) United States
(12) Patent Application Publication
(10) Pub. No.: US 2025/0260287 A1
(43) Pub. Date: Aug. 14, 2025

(54) ELECTRIC COMPRESSOR

(71) Applicant: KABUSHIKI KAISHA TOYOTA JIDOSHOKKI, Aichi (JP)

(72) Inventors: Shumpei YAMAKAGE, Aichi (JP); Yusuke KINOSHITA, Aichi (JP)

(73) Assignee: KABUSHIKI KAISHA TOYOTA JIDOSHOKKI, Aichi (JP)

(21) Appl. No.: 19/022,022

(22) Filed: Jan. 15, 2025

(30) Foreign Application Priority Data
Feb. 13, 2024 (JP) 2024-019341

(51) Int. Cl. H02K 3/50; F25B 31/02; H02K 11/33; H02K 21/14

(52) U.S. Cl. CPC H02K 3/50; H02K 11/33; H02K 21/14; F25B 31/026

(57) ABSTRACT

An electric compressor includes: a housing; a compression mechanism accommodated in the housing and configured to compress a fluid; a motor accommodated in the housing and configured to drive the compression mechanism; an inverter accommodated in the housing and configured to drive the motor; and a hermetic terminal disposed in the housing, and electrically connecting the motor and the inverter. The hermetic terminal includes: a conductive member made of a conductive material; a support plate having a plate-like shape and made of metal; and an insulator. The support plate supports the conductive member. The insulator provides electrical insulation between the conductive member and the support plate. The electric compressor includes a reinforcing plate having a plate-like shape. The support plate and the reinforcing plate for enhancing rigidity of the support plate are fastened together to the housing by a fastening member.

### CROSS-REFERENCE TO RELATED APPLICATION

This application claims priority to Japanese Patent Application No. 2024-019341 filed on Feb. 13, 2024, the entire disclosure of which is incorporated herein by reference.

The present disclosure relates to an electric compressor.

### BACKGROUND ART

The electric compressor includes a compression mechanism, a motor, an inverter, and a housing. The compression mechanism compresses a fluid. The motor drives the compression mechanism. The inverter drives the motor. The housing accommodates the compression mechanism, the motor, and the inverter. The electric compressor further includes a hermetic terminal. The hermetic terminal is disposed in the housing and electrically connects the motor and the inverter. For example, as in Japanese Patent Application Publication No. 2005-155369, the hermetic terminal includes a conductive member, a support plate, and an insulator. The conductive member is made of a conductive material. The support plate has a plate-like shape and supports the conductive member. The insulator provides electrical insulation between the conductive member and the support plate.

Such an electric compressor may use a natural refrigerant, such as carbon dioxide or propane gas. It is necessary to enhance the rigidity of the support plate depending on the type of refrigerant. One option to enhance the rigidity of the support plate is to increase the thickness of the support plate. However, it is difficult to provide, for example, a sintered glass insulator between such a support plate having an increased thickness and the conductive member during manufacturing. Therefore, it is desired to enhance the rigidity of the support plate without increasing the thickness of the support plate.

The present disclosure, which has been made in light of the above-described problem, is directed to providing an electric compressor that includes a support plate with enhanced rigidity without increasing the thickness of the support plate.

### SUMMARY

In accordance with an aspect of the present disclosure, there is provided an electric compressor that includes: a housing; a compression mechanism accommodated in the housing and configured to compress a fluid; a motor accommodated in the housing and configured to drive the compression mechanism; an inverter accommodated in the housing and configured to drive the motor; and a hermetic terminal disposed in the housing, and electrically connecting the motor and the inverter. The hermetic terminal includes: a conductive member made of a conductive material; a support plate having a plate-like shape and made of metal; and an insulator. The support plate supports the conductive member. The insulator provides electrical insulation between the conductive member and the support plate. The electric compressor includes a reinforcing plate having a plate-like shape. The support plate and the reinforcing plate for enhancing rigidity of the support plate are fastened together to the housing by a fastening member.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a sectional view of an electric compressor according to an embodiment of the present disclosure;

FIG. 2 is a fragmentary enlarged sectional view of the electric compressor according to the embodiment;

FIG. 3 is an exploded perspective view of a hermetic terminal; and

FIG. 4 is a fragmentary enlarged sectional view of the electric compressor according to the embodiment.

### DETAILED DESCRIPTION OF THE EMBODIMENTS

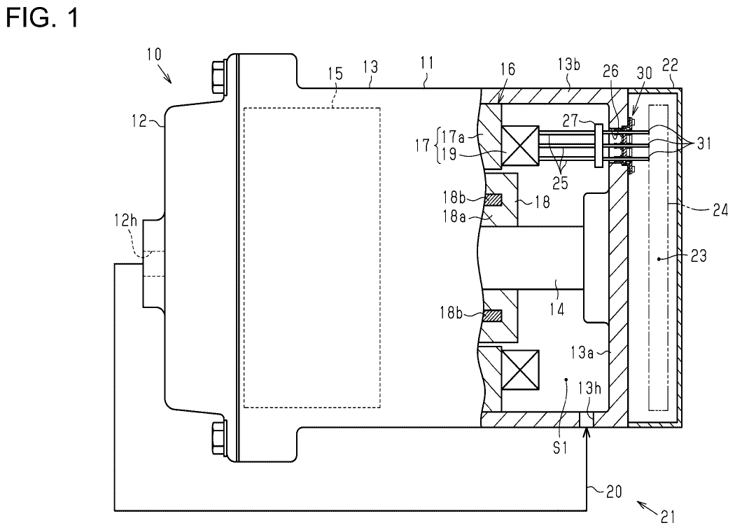

The following will describe an embodiment of an electric compressor with reference to accompanying FIGS. 1 to 4. The electric compressor of the embodiment is applied, for example, to a vehicle air conditioner.

FIG. 1 illustrates an electric compressor 10 that includes a housing 11. The housing 11 includes a discharge housing 12, and a motor housing 13. The discharge housing 12 and the motor housing 13 have a cylindrical shape. The motor housing 13 is connected to the discharge housing 12. Each of the discharge housing 12 and the motor housing 13 is made of a metallic material. For example, each of the discharge housing 12 and the motor housing 13 is made of aluminum. The motor housing 13 includes an end wall 13a having a plate-like shape and a peripheral wall 13b having a cylindrical shape. The peripheral wall 13b extends from an outer peripheral portion of the end wall 13a.

The electric compressor 10 includes a rotary shaft 14. The rotary shaft 14 is accommodated in the motor housing 13. That is, the rotary shaft 14 is accommodated in the housing 11. The rotary shaft 14 is rotatably supported by the motor housing 13.

The electric compressor 10 includes a compression mechanism 15 and a motor 16. The compression mechanism 15 and the motor 16 are accommodated in the motor housing 13. That is, the housing 11 accommodates the compression mechanism 15 and the motor 16. The compression mechanism 15 and the motor 16 are arranged in an axial direction of the rotary shaft 14. The motor 16 is disposed between the compression mechanism 15 and the end wall 13a of the motor housing 13. In the motor housing 13, a space between the compression mechanism 15 and the end wall 13a of the motor housing 13 serves as a motor chamber S1 for accommodating the motor 16. That is, the housing 11 has the motor chamber S1.

The compression mechanism 15 is driven by the rotation of the rotary shaft 14. The compression mechanism 15 is configured to compress refrigerant as a fluid. The compression mechanism 15 is, for example, a scroll compression mechanism that includes a fixed scroll (not illustrated) fixed to the motor housing 13 and a movable scroll (not illustrated) facing the fixed scroll. The refrigerant compressed by the compression mechanism 15 is, for example, a natural refrigerant, such as carbon dioxide or propane gas.

The motor 16 includes a stator 17 having a cylindrical shape and a rotor 18 having a cylindrical shape. The rotor 18 is disposed inside the stator 17. The rotor 18 is rotatable together with the rotary shaft 14. The rotor 18 includes a rotor core 18a and a plurality of permanent magnets 18b. The rotor core 18a is fixed to the rotary shaft 14. The permanent magnets 18b are disposed in the rotor core 18a. The stator 17 surrounds the rotor 18. The stator 17 includes a stator core 17a having a cylindrical shape and a motor coil 19. The motor coil 19 is wound around the stator core 17a. As power is supplied to the motor coil 19, the rotor 18 rotates, and the rotary shaft 14 rotates together with the rotor 18. The compression mechanism 15 is driven by the rotation of the rotary shaft 14. Accordingly, the motor 16 drives the compression mechanism 15.

The housing 11 has a suction port 13h. The suction port 13h is formed in a portion of the peripheral wall 13b adjacent to the end wall 13a. The refrigerant is drawn into the motor chamber S1 through the suction port 13h. The suction port 13h is connected to a first end of an external refrigerant circuit 20. The housing 11 has a discharge port 12h. The discharge port 12h is formed in the discharge housing 12. The discharge port 12h is connected to a second end of the external refrigerant circuit 20.

The refrigerant is drawn into the motor chamber S1 from the first end of the external refrigerant circuit 20 through the suction port 13h, and compressed by the compression mechanism 15. The refrigerant compressed by the compression mechanism 15 flows out to the second end of the external refrigerant circuit 20 through the discharge port 12h. The refrigerant passes through a heat exchanger and an expansion valve of the external refrigerant circuit 20, and returns to the motor chamber S1 through the suction port 13h. The electric compressor 10 and the external refrigerant circuit 20 cooperate to form a vehicle air conditioner 21.

The electric compressor 10 includes an inverter cover 22. The inverter cover 22 is a part of the housing 11. That is, the housing 11 includes the inverter cover 22. The inverter cover 22 has a cylindrical shape. The inverter cover 22 is connected to the end wall 13a of the motor housing 13. The end wall 13a of the motor housing 13 and the inverter cover 22 cooperate to define an inverter chamber 23. That is, the housing 11 has the inverter chamber 23. The end wall 13a of the motor housing 13 serves as a partition wall of the present disclosure that separates the motor chamber S1 from the inverter chamber 23.

The electric compressor 10 includes an inverter 24. The inverter 24 is accommodated in the inverter chamber 23. The inverter 24 drives the motor 16. The compression mechanism 15, the motor 16, and the inverter 24 are arranged in this order in the axial direction of the rotary shaft 14. The housing 11 accommodates the compression mechanism 15, the motor 16, and the inverter 24.

The electric compressor 10 includes a plurality of motor wires 25. The motor wires 25 extend from the motor coil 19 of the motor 16. Specifically, three motor wires 25 extend from a portion of the motor coil 19 adjacent to the end wall 13a of the motor housing 13. The motor coil 19 includes a U-phase motor coil, a V-phase motor coil, and a W-phase motor coil, and the three motor wires 25 extend from the U-phase motor coil, the V-phase motor coil, and the W-phase motor coil, respectively. The windings of the motor coil 19 are covered with an insulating coating, and the windings partly extend from the motor coil 19 and serve as the motor wires 25.

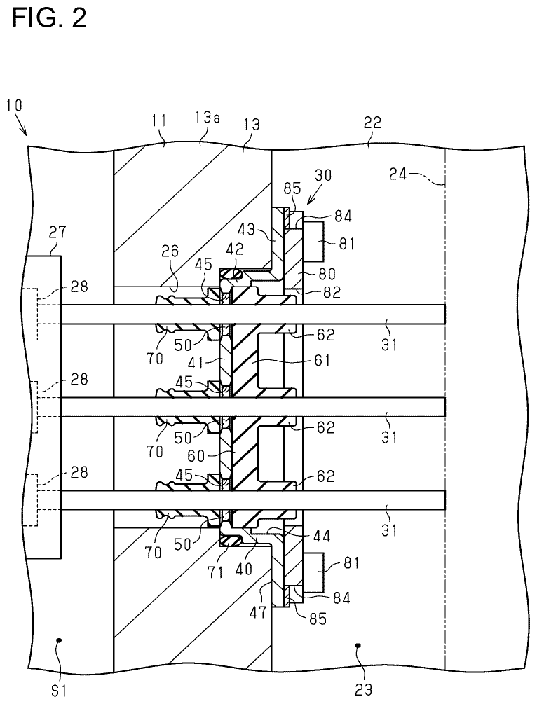

As illustrated in FIG. 2, the end wall 13a of the motor housing 13 has a first insertion hole 26. The first insertion hole 26 penetrates the end wall 13a of the motor housing 13 in a thickness direction of the end wall 13a. The first insertion hole 26 is located outward of the center portion of the end wall 13a of the motor housing 13 in a radial direction of the rotary shaft 14. A first end of the first insertion hole 26 is opened on a surface of the end wall 13a that faces the motor chamber S1. A second end of the first insertion hole 26 is opened on a surface of the end wall 13a that faces the inverter chamber 23.

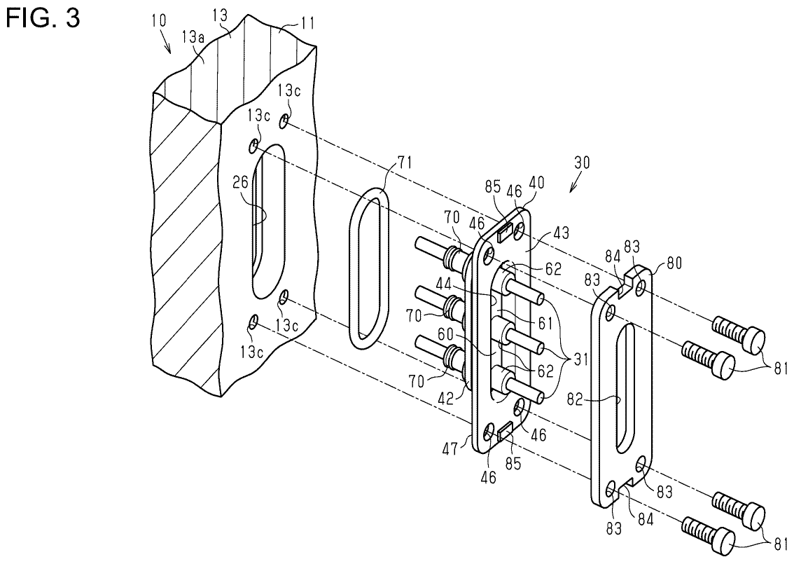

As illustrated in FIGS. 2 and 3, the electric compressor 10 includes a hermetic terminal 30. The hermetic terminal 30 is disposed on the end wall 13a of the motor housing 13. That is, the hermetic terminal 30 is disposed in the housing 11. The hermetic terminal 30 seals the motor chamber S1 and the inverter chamber 23, and electrically connects the motor 16 and the inverter 24.

The hermetic terminal 30 includes a plurality of conductive members 31 (in this embodiment, three conductive members 31), a support plate 40, and a plurality of insulators 50 (in this embodiment, three insulators 50). Each of the conductive member 31 is made of a conductive material. The conductive members 31 of the hermetic terminal 30 respectively correspond to the U-phase motor coil, the V-phase motor coil, and the W-phase motor coil of the motor coil 19. Each of the conductive members 31 is a cylindrical metal pin that extends linearly. The conductive member 31 is inserted through the first insertion hole 26. The conductive members 31 extend parallel to each other. The first end of each conductive member 31 extends into the inverter chamber 23 through the first insertion hole 26. The first end of the conductive member 31 is electrically connected to the inverter 24. The second end of each conductive member 31 extends into the motor chamber S1 through the first insertion hole 26.

The second end of the conductive member 31 is electrically connected to a corresponding one of the motor wires 25 via a connecting terminal 28 in a cluster block 27. The power is supplied from the inverter 24 to the motor 16 via the conductive member 31, the connecting terminal 28, and the motor wire 25. Accordingly, the motor 16 is driven.

The support plate 40 has a plate-like shape. The support plate 40 is made of metal. For example, the support plate 40 is made of steel. The support plate 40 has an elongated rectangular plate shape in a planar view. The support plate 40 has a plate end wall 41, a plate cylindrical wall 42, and a plate flange wall 43.

The plate end wall 41 has an elongated plate shape. The plate cylindrical wall 42 extends cylindrically from an outer peripheral portion of the plate end wall 41. The plate cylindrical wall 42 has an elongated rectangular cylindrical shape.

The plate flange wall 43 has an annular shape, and extends outwardly from an end of the plate cylindrical wall 42, which is the end distant from the plate end wall 41. The plate flange wall 43 has an elongated rectangular annular shape. The plate end wall 41 and the plate cylindrical wall 42 define a recess 44. That is, the support plate 40 has the recess 44.

The plate end wall 41 has three plate through holes 45. Each of the plate through holes 45 penetrates the plate end wall 41 in a thickness direction of the plate end wall 41. The plate through holes 45 are arranged in a longitudinal direction of the support plate 40. The conductive member 31 is inserted through a corresponding one of the plate through holes 45.

The three insulators 50 of the hermetic terminal 30 correspond to the conductive members 31, respectively. Each of the insulators 50 is disposed inside a corresponding one of the plate through holes 45. The insulator 50 is a glass member with electrical insulation properties. The insulator 50 is a sintered glass insulator. The insulator 50 is disposed between the conductive member 31 and the plate end wall 41. The insulator 50 provides electrical insulation between the conductive member 31 and the plate end wall 41. That is, the insulator 50 provides electrical insulation between the conductive member 31 and the support plate 40. The support plate 40 supports the conductive member 31 with the support plate 40 electrically insulated from the conductive member 31 by the insulator 50.

Specifically, in the manufacturing process of the hermetic terminal 30, firstly, the conductive member 31 and the support plate 40 are aligned with each other and heated. Then, glass is poured between the insulator 50 and the conductive member 31, and cooled to solidify. Through this manufacturing process, the glass sintered insulator 50 is disposed between the conductive member 31 and the plate end wall 41.

As illustrated in FIG. 3, the support plate 40 has a plurality of first holes 46 (in this embodiment, four first holes 46). The first holes 46 each have a circular hole shape. The first holes 46 are formed through the plate flange wall 43. The first holes 46 penetrate the plate flange wall 43 in a thickness direction of the plate flange wall 43. The first holes 46 are located at four corners of the plate flange wall 43, respectively. Also, the first holes 46 are arranged around the opening of the recess 44 of the plate flange wall 43.

As illustrated in FIG. 2, the support plate 40 is disposed in the inverter chamber 23 and fixed to the end wall 13a of the motor housing 13. The recess 44 is inserted into the first insertion hole 26, and supports the conductive member 31. The support plate 40 is fixed to the end wall 13a of the motor housing 13 and closes the first insertion hole 26. The plate flange wall 43 faces a part of the end wall 13a of the motor housing 13 around the first insertion hole 26. The plate flange wall 43 of the support plate 40 has opposite surfaces, and one surface of the opposite surfaces faces the end wall 13a of the motor housing 13 and serves as a contact surface 47 of the support plate 40 that is in contact with the housing 11. In such a way, the support plate 40 is disposed in the inverter chamber 23.

An insulating member 60 is disposed in the recess 44. The insulating member 60 is made of a rubber material. The insulating member 60 has a base portion 61 having a plate-like shape and three cylindrical portions 62. The base portion 61 is disposed in the recess 44, and is in close contact with the plate end wall 41. An outer peripheral part of the base portion 61 extends along the plate cylindrical wall 42. The base portion 61 has opposite surfaces, and one surface of the opposite surfaces faces the plate end wall 41. The cylindrical portions 62 extend cylindrically from the other surface of the opposite surfaces of the base portion 61.

The conductive member 31 is inserted through a corresponding one of the cylindrical portions 62 and the base portion 61. That is, the conductive member 31 penetrates the insulating member 60. The cylindrical portion 62 protrudes from a surface of the plate flange wall 43, which is not a surface connected to the plate cylindrical wall 42. That is, the end of the cylindrical portion 62 extending from the base portion 61 protrudes from the recess 44. The insulating member 60 provides electrical insulation between the conductive member 31 and the support plate 40.

The hermetic terminal 30 includes three hermetic insulating members 70. Each of the hermetic insulating members 70 is made of a rubber material. The hermetic insulating member 70 has a cylindrical shape. Each of the conductive members 31 is inserted through a corresponding one of the hermetic insulating members 70. The hermetic insulating member 70 covers a part of the conductive member 31, which protrudes from the plate end wall 41 and is located inside the first insertion hole 26. The hermetic insulating member 70 provides electrical insulation between the conductive member 31 and the end wall 13a of the motor housing 13.

The hermetic terminal 30 includes a sealing member 71. The sealing member 71 has an annular shape. The sealing member 71 is an O-ring made of a rubber material. The sealing member 71 is disposed between an outer surface of the plate cylindrical wall 42 and an inner peripheral surface of the first insertion hole 26. The sealing member 71 seals a gap between the outer surface of the plate cylindrical wall 42 and the inner peripheral surface of the first insertion hole 26. That is, the sealing member 71 seals the gap between the support plate 40 and the inner peripheral surface of the first insertion hole 26. The sealing member 71 is arranged to overlap with the support plate 40 and a reinforcing plate 80 in an axial direction of the sealing member 71.

As illustrated in FIGS. 2 and 3, the reinforcing plate 80 and the support plate 40 are fastened together to the end wall 13a of the motor housing 13 by a plurality of bolts 81, which each serve as the fastening member of the present disclosure. That is, the support plate 40 and the reinforcing plate 80 are fastened together to the housing 11 by the bolts 81. The reinforcing plate 80 is made of metal. For example, the reinforcing plate 80 is made of steel. The reinforcing plate 80 has an elongated rectangular plate shape in a planar view. The reinforcing plate 80 enhances the rigidity of the support plate 40.

The plate flange wall 43 is disposed between the reinforcing plate 80 and the end wall 13a of the motor housing 13. That is, the support plate 40 is disposed between the reinforcing plate 80 and the housing 11. A thickness direction of the reinforcing plate 80 and the thickness direction of the plate flange wall 43 of the support plate 40 are aligned with each other. In such a way, the reinforcing plate 80 is disposed in the inverter chamber 23.

The reinforcing plate 80 has a second insertion hole 82. The conductive members 31 are inserted through the second insertion hole 82. The second insertion hole 82 extends along the opening of the recess 44. The second insertion hole 82 is smaller than the opening of the recess 44. The second insertion hole 82 and the opening of the recess 44 have similar shapes. The second insertion hole 82 of the reinforcing plate 80 is connected to the recess 44 of the support plate 40. A portion of the reinforcing plate 80 around the second insertion hole 82 partly covers the opening of the recess 44. That is, the reinforcing plate 80 covers the opening of the recess 44.

The end of each cylindrical portion 62 extending from the base portion 61 of the insulating member 60 protrudes from the recess 44 and is positioned inside the second insertion hole 82. That is, an end of the cylindrical portion 62 is surrounded by the second insertion hole 82. That is, the insulating member 60 is surrounded by the second insertion hole 82.

As illustrated in FIG. 3, the reinforcing plate 80 has a plurality of second holes 83 (in this embodiment, four second holes 83). The second holes 83 each have a circular hole shape. The second holes 83 penetrate the reinforcing plate 80 in the thickness direction of the reinforcing plate 80. The second holes 83 are located at four corners of the reinforcing plate 80, respectively. Also, the second holes 83 are located around the second insertion hole 82 of the reinforcing plate 80. Each of the second holes 83 of the reinforcing plate 80 is connected to a corresponding one of the first holes 46.

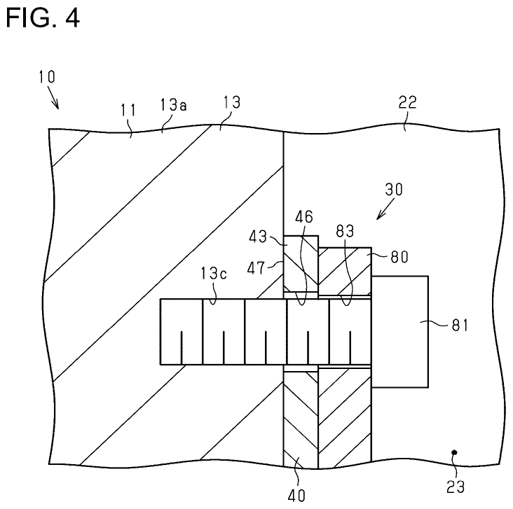

As illustrated in FIG. 4, a diameter of the second hole 83 is smaller than a diameter of the first hole 46. A part of the reinforcing plate 80 around the second hole 83 partly covers the first hole 46. Each of the bolts 81 is inserted through the second hole 83 and the first hole 46. The bolt 81 is screwed into a female screw hole 13c of the end wall 13a of the motor housing 13 through the second hole 83 and the first hole 46 to fix the support plate 40 and the reinforcing plate 80 to the end wall 13a of the motor housing 13.

As illustrated in FIGS. 2 and 3, the reinforcing plate 80 has a pair of cutouts 84. The reinforcing plate 80 has opposite ends that define the reinforcing plate 80 in a longitudinal direction of the reinforcing plate 80, and the cutouts 84 are respectively formed at edges of the opposite ends of the reinforcing plate 80. The cutouts 84 penetrate the reinforcing plate 80 in the thickness direction of the reinforcing plate 80.

The plate flange wall 43 of the support plate 40 has the opposite surfaces, and the one surface of the opposite surfaces faces the end wall 13a of the motor housing 13 and serves as the contact surface 47. The plate flange wall 43 has, on the other surface of the opposite surfaces, a plurality of information members 85 indicating predetermined information. That is, the support plate 40 has the opposite surfaces, and one surface of the opposite surfaces serves as the contact surface 47. The support plate 40 has, on the other surface of the opposite surfaces, the plurality of information members 85 indicating predetermined information. The information members 85 are disposed on the other surface respectively on opposite sides in a longitudinal direction of the plate end wall 41. The information members 85 are exposed through the cutouts 84, respectively. In other words, each of the cutouts 84 serves as the exposure portion of the present disclosure through which the information member 85 is exposed. That is, the reinforcing plate 80 has the exposure portion of the present disclosure through which the information member 85 is exposed. The information member 85 may indicate information, such as a manufacturing location and manufacturing date of the hermetic terminal 30, or information on the electric compressor 10. The information member 85 is, for example, a QR code (registered trademark) or a barcode. The information member 85 may be a sticker indicating predetermined information. FIGS. 2 and 3 schematically illustrate the information member 85.

### Operation

The following will describe the operation of the electric compressor 10 according to the present embodiment.

In the electric compressor 10, the pressure of the refrigerant drawn into the motor chamber S1 acts on the support plate 40 through the first insertion hole 26. The support plate 40 and the reinforcing plate 80 for enhancing the rigidity of the support plate 40 are fastened together to the end wall 13a of the motor housing 13 by the bolts 81. This configuration enhances the rigidity of the support plate 40. This configuration therefore enables the support plate 40 to withstand the pressure of the refrigerant.

When the end wall 13a of the motor housing 13 is cooled by the refrigerant drawn into the motor chamber S1, water may condense on the support plate 40 located between the end wall 13a of the motor housing 13 and the reinforcing plate 80. The water may flow along the recess 44, however, the reinforcing plate 80, which covers the opening of the recess 44 as illustrated in FIG. 2, blocks the water.

Furthermore, the reinforcing plate 80 blocks the water flowing through the first hole 46 since the diameter of the second hole 83 is smaller than that of the first hole 46 as illustrated in FIG. 4. This configuration prevents the water from entering the inverter chamber 23.

The aforementioned embodiment may achieve the following advantageous effects.

(1) The support plate 40 and the reinforcing plate 80 for enhancing the rigidity of the support plate 40 are fastened together to the housing 11 by the bolts 81. This configuration allows the support plate 40 to have enhanced rigidity without increasing the thickness of the support plate 40.

(2) The support plate 40 is disposed between the reinforcing plate 80 and the housing 11. This configuration facilitates the alignment of the reinforcing plate 80 with the support plate 40, thereby facilitating the assembly of the reinforcing plate 80. This also facilitates visual check of the reinforcing plate 80 to confirm that the reinforcing plate 80 has been mounted. In particular, this facilitates visual check for detecting incorrect assembly of the reinforcing plate 80 if the support plate 40 is selected from multiple types of support plates depending on the type of refrigerant.

(3) The reinforcing plate 80 covers the opening of the recess 44, thereby blocking the water flowing along the recess 44. This increases the reliability of the electric compressor 10.

(4) The insulating member 60 is surrounded by the second insertion hole 82. The presence of the insulating member 60 facilitates ensuring electrical insulation between the reinforcing plate 80 and the conductive member 31. This configuration further increases the reliability of the electric compressor 10.

(5) The diameter of the second hole 83 is smaller than that of the first hole 46. This configuration allows the reinforcing plate 80 to block the water flowing through the first hole 46. This increases the reliability of the electric compressor 10.

(6) Although the support plate 40 and the reinforcing plate 80 are disposed in the inverter chamber 23, the electric compressor 10 allows the support plate 40 to have enhanced rigidity without increasing the thickness of the support plate 40.

(7) The reinforcing plate 80 has the cutouts 84. The presence of each of the cutouts 84 allows the exposure of the information member 85, which is disposed on the surface of the support plate 40 opposite to the contact surface 47 that is in contact with the housing 11.

(8) For example, if the thickness of the plate flange wall 43 is increased to enhance the rigidity of the support plate 40 instead of providing the reinforcing plate 80, the plate flange wall 43 becomes thicker than the rest of the support plate 40. This structure may cause distortion of the support plate 40 when the support plate 40 is heated and cooled in order to dispose the insulator 50 between the conductive member 31 and the plate end wall 41. According to the present embodiment, the rigidity of the support plate 40 is enhanced without increasing the thickness of the support plate 40. This prevents the distortion of the support plate 40 that may occur when the support plate 40 is heated and cooled. This therefore facilitates the manufacturing of the hermetic terminal 30 including the insulator 50, e.g., a sintered glass insulator, between the conductive member 31 and the support plate 40.

(9) The reinforcing plate 80 covers the opening of the recess 44, thereby blocking the water flowing along the recess 44. The reinforcing plate 80 also blocks the water flowing through the first hole 46 since the diameter of the second hole 83 is smaller than that of the first hole 46. This prevents the condensation of the water on the support plate 40, thereby preventing the water from entering the inverter chamber 23. This therefore prevents the water from causing the occurrence of failures in the inverter 24.

(10) The sealing member 71 is arranged to overlap with the support plate 40 and the reinforcing plate 80 in the axial direction of the sealing member 71. This configuration ensures the sealing performance of the sealing member 71, if the sealing member 71 is an O-ring.

The aforementioned embodiment may be modified as below. The embodiment and the following modifications may be combined with each other within technically consistent range.

In the embodiment, the reinforcing plate 80 may be disposed between the plate flange wall 43 of the support plate 40 and the housing 11. That is, the support plate 40 does not necessarily have to be disposed between the reinforcing plate 80 and the housing 11.

In the embodiment, the reinforcing plate 80 does not necessarily have to cover the opening of the recess 44.

In the embodiment, the end of each cylindrical portion 62 extending from the base portion 61 of the insulating member 60 may protrude from the second insertion hole 82. That is, the insulating member 60 may protrude from the second insertion hole 82.

In the embodiment, the end of each cylindrical portion 62 extending from the base portion 61 of the insulating member 60 protrudes from the recess 44, but does not necessarily have to be positioned inside the second insertion hole 82. That is, the insulating member 60 does not necessarily have to be surrounded by the second insertion hole 82.

In the embodiment, the diameter of the second hole 83 may be equal to or greater than the diameter of the first hole 46.

In the embodiment, the support plate 40 and the reinforcing plate 80 may be disposed in the motor chamber S1.

In the embodiment, the reinforcing plate 80 may have a through hole, for example, which serves as the exposure portion of the present disclosure through which the information member 85 is exposed. That is, the exposure portion of the present disclosure through which the information member 85 is exposed is not limited to the cutout 84.

In the embodiment, the support plate 40 does not necessarily have to have the information member 85 on the surface opposite to the contact surface 47 that is in contact with the housing 11.

In the embodiment, for example, a press-fit pin may be used as the fastening member of the present disclosure, instead of the bolt 81.

In the embodiment, the electric compressor 10 may include: a bottomed-cylindrical covering body formed separately from the motor housing 13 and attached to the end wall 13a of the motor housing 13; and a lid member for closing an opening of the covering body, and the inverter chamber 23 may be defined by the covering body and the lid member. This configuration allows the end wall 13a of the motor housing 13 and a bottom wall of the covering body cooperate to serve as the partition wall of the present disclosure that separates the motor chamber S1 from the inverter chamber 23. The first insertion hole 26 may penetrate the end wall 13a of the motor housing 13 and the bottom wall of the covering body.

In the electric compressor 10 of the embodiment, for example, the inverter 24 may be disposed outward of the housing 11 in the radial direction of the rotary shaft 14. That is, the compression mechanism 15, the motor 16, and the inverter 24 do not necessarily have to be arranged in this order in the axial direction of the rotary shaft 14.

In the embodiment, the compression mechanism 15 is not limited to a scroll compression mechanism. The compression mechanism 15 may be a compression mechanism, such as a piston compression mechanism, a vane compression mechanism, or a rotary compression mechanism.

In the embodiment, the electric compressor 10 is included in the vehicle air conditioner 21, but the electric compressor 10 may be mounted to a fuel cell vehicle and be configured to compress air as a fluid, which is supplied to a fuel cell, with the compression mechanism 15.

The following will describe technical ideas derived from the above-described embodiments and modifications.

### Appendix 1

An electric compressor comprising:

a housing;

a compression mechanism accommodated in the housing and configured to compress a fluid;

a motor accommodated in the housing and configured to drive the compression mechanism;

an inverter accommodated in the housing and configured to drive the motor; and

a hermetic terminal disposed in the housing, and electrically connecting the motor and the inverter,

the hermetic terminal including:
a conductive member made of a conductive material;
a support plate having a plate-like shape and made of metal, the support plate supporting the conductive member; and
an insulator that provides electrical insulation between the conductive member and the support plate, wherein

the electric compressor includes a reinforcing plate having a plate-like shape, and

the support plate and the reinforcing plate for enhancing rigidity of the support plate are fastened together to the housing by a fastening member.

### Appendix 2

The electric compressor according to appendix 1, wherein
the support plate is disposed between the reinforcing plate and the housing.

### Appendix 3

The electric compressor according to appendix 1 or 2, wherein

the housing includes a partition wall that separates a motor chamber for accommodating the motor from an inverter chamber for accommodating the inverter,

the partition wall has a first insertion hole through which the conductive member is inserted,

the support plate has a recess that is inserted into the first insertion hole and supports the conductive member,

the reinforcing plate has a second insertion hole through which the conductive member is inserted, and

the reinforcing plate covers an opening of the recess.

### Appendix 4

The electric compressor according to appendix 3, wherein

the conductive member penetrates an insulating member disposed in the recess,

the insulating member provides electrical insulation between the conductive member and the support plate, and

the insulating member is surrounded by the second insertion hole.

### Appendix 5

The electric compressor according to any one of appendices 1 to 4, wherein

the support plate has a first hole through which the fastening member is inserted,

the reinforcing plate has a second hole through which the fastening member is inserted, and

a diameter of the second hole is smaller than a diameter of the first hole.

### Appendix 6

The electric compressor according to appendix 3, wherein

the support plate and the reinforcing plate are disposed in the inverter chamber.

### Appendix 7

The electric compressor according to any one of appendices 1 to 6, wherein

the support plate has opposite surfaces, and one surface of the opposite surfaces serves as a contact surface in contact with the housing,

the support plate has, on the other surface of the opposite surfaces, an information member indicating predetermined information, and

the reinforcing plate has an exposure portion through which the information member is exposed.

What is claimed is:

1. An electric compressor comprising:
a housing;
a compression mechanism accommodated in the housing and configured to compress a fluid;
a motor accommodated in the housing and configured to drive the compression mechanism;
an inverter accommodated in the housing and configured to drive the motor; and
a hermetic terminal disposed in the housing, and electrically connecting the motor and the inverter,
the hermetic terminal including:
a conductive member made of a conductive material;
a support plate having a plate-like shape and made of metal, the support plate supporting the conductive member; and
an insulator that provides electrical insulation between the conductive member and the support plate, wherein
the electric compressor includes a reinforcing plate having a plate-like shape, and
the support plate and the reinforcing plate for enhancing rigidity of the support plate are fastened together to the housing by a fastening member.

2. The electric compressor according to claim 1, wherein
the support plate is disposed between the reinforcing plate and the housing.

3. The electric compressor according to claim 1, wherein
the housing includes a partition wall that separates a motor chamber for accommodating the motor from an inverter chamber for accommodating the inverter,
the partition wall has a first insertion hole through which the conductive member is inserted,
the support plate has a recess that is inserted into the first insertion hole and supports the conductive member,
the reinforcing plate has a second insertion hole through which the conductive member is inserted, and
the reinforcing plate covers an opening of the recess.

4. The electric compressor according to claim 3, wherein
the conductive member penetrates an insulating member disposed in the recess,
the insulating member provides electrical insulation between the conductive member and the support plate, and
the insulating member is surrounded by the second insertion hole.

5. The electric compressor according to claim 1, wherein
the support plate has a first hole through which the fastening member is inserted,
the reinforcing plate has a second hole through which the fastening member is inserted, and
a diameter of the second hole is smaller than a diameter of the first hole.

6. The electric compressor according to claim 3, wherein
the support plate and the reinforcing plate are disposed in the inverter chamber.

7. The electric compressor according to claim 1, wherein
the support plate has opposite surfaces, and one surface of the opposite surfaces serves as a contact surface in contact with the housing,
the support plate has, on the other surface of the opposite surfaces, an information member indicating predetermined information, and
the reinforcing plate has an exposure portion through which the information member is exposed.
